(19) United States
(12) Patent Application Publication
(10) Pub. No.: US 2024/0269805 A1
(43) Pub. Date: Aug. 15, 2024

(54) WRENCH WITH OVER-CENTER JAWS

(71) Applicant: The Charles Machine Works, Inc., Perry, OK (US)

(72) Inventor: Stephan Ulrich Berger, West Salem, OH (US)

(21) Appl. No.: 18/441,097

(22) Filed: Feb. 14, 2024

Related U.S. Application Data
(60) Provisional application No. 63/485,144, filed on Feb. 15, 2023.

(51) Int. Cl. B25B 13/50

(52) U.S. Cl. CPC B25B 13/5041

(57) ABSTRACT

A drilling machine having a three jaw system on each of two wrench assemblies, for gripping and rotating a pipe. Each wrench assembly has a frame, and hosts a trio of jaws: a lower jaw on a sliding subframe, and two upper jaws, each on an arm which is pivotally attached to the sliding subframe. Actuators, such as hydraulic cylinders, extend between the frame and one of the arms. As actuators extend, the subframe is carried toward a pipe joint. Upon contact between the pipe joint and the lower jaw, the arms pivot, causing the upper jaws to contact and grip the pipe joint. The wrenches of the wrench assembly may be adjustable relative to one another along a longitudinal axis of the pipe.

### SUMMARY

The present invention is directed to a pipe wrench. The pipe wrench comprises a first frame, a second frame, a first arm, a second arm, a first cylinder, and a second cylinder. The second frame is slidingly supported by the first frame. The first arm and second arm are pivotally attached to the first frame and the second frame at respective first and second pivot points.

The first cylinder is attached at a first end to the first frame and at a second end to the first arm at a third pivot point. The second cylinder is attached at a first end to the first frame and a second end to the second arm at a fourth pivot point. The first pivot point and second pivot point are separated by a first distance. The first and second cylinder are configured to move the first and second arm from a first condition to a second condition. The first condition is defined by the third and fourth pivot points being separated by a distance greater than the first distance and the second condition is defined by the third and fourth pivot points being separated by a distance less than the first distance.

In another aspect, the present invention is directed to a pipe wrench assembly. The pipe wrench assembly comprises a stationary wrench and a rotating wrench. The rotating wrench is rotatable relative to the stationary wrench. The stationary wrench comprises a first jaw, second jaw, and third jaw. The second jaw and third jaw are each pivotal relative to the first jaw. The rotating wrench comprises a fourth jaw, a fifth jaw, and a sixth jaw. The fifth jaw and sixth jaw are each pivotal relative to the fourth jaw.

### BRIEF DESCRIPTION OF THE DRAWINGS

FIG. 1 is a right front top perspective view of a wrench for use with a horizontal directional drilling machine.

FIG. 2 is a front view thereof, with the rotating wrench slightly rotated counter-clockwise relative to the stationary wrench.

FIG. 3A is a left front top view of the wrench assembly of FIG. 1, with the frame of the stationary wrench removed such that internal components of the wrench assembly can be viewed. The wrench is “open” in FIG. 3A.

FIG. 3B is the view of FIG. 3A with the wrench “closed.”

FIG. 4 is a right front view of the arrangement of FIGS. 3A-3B.

FIG. 5A is a front view thereof, with the rotating wrench slightly rotated such that the third jaw of the rotating wrench is visible behind the third jaw of the stationary wrench. The front frame element of the stationary wrench is removed in FIG. 5, and the wrench is “open”.

FIG. 5B is the view of FIG. 5A with the wrench “closed.”

FIG. 6 is a right front top perspective view of the rotating wrench, with the stationary wrench removed for clarity.

FIG. 7 is a left front top view thereof with adjustment cylinders shown. In FIGS. 6 and 7, the rotating wrench is rotated counter-clockwise to the limit of its rotation within the slots of the rotation plate.

FIG. 8 is a bottom view of the wrench assembly, showing the adjustment cylinders disposed between the rotating and stationary wrenches.

FIG. 9 is a top perspective view of a horizontal directional drill using the wrench assembly of the present invention.

FIG. 10 is a back right view of the wrench assembly with the rotation frame removed such that elements of the cylinders used for rotation of the rotating wrench may be seen.

FIG. 11 is a top front side view of the wrench assembly, with the third jaw in each of the movable and rotating wrenches visible. In the embodiment of FIG. 11, the third jaw has a removable die assembly. Frame elements have been removed to show the inner frame.

FIG. 12 is a front view thereof.

FIG. 13 is a top front view of the removable die assembly for use with a jaw of the wrench assembly.

FIG. 14A is a side view of an insert for use in the removable die assembly.

FIG. 14B is a top front side view thereof.

### DETAILED DESCRIPTION

Turning now to the figures, a wrench assembly 10 for a horizontal directional drilling machine 100 is shown therein. Such machines are used to connect, advance, and disconnect pipe segments that form a drill string. This drill string may be used to install a product line (such as a utility line, culvert, or other underground line) or may constitute the product line itself.

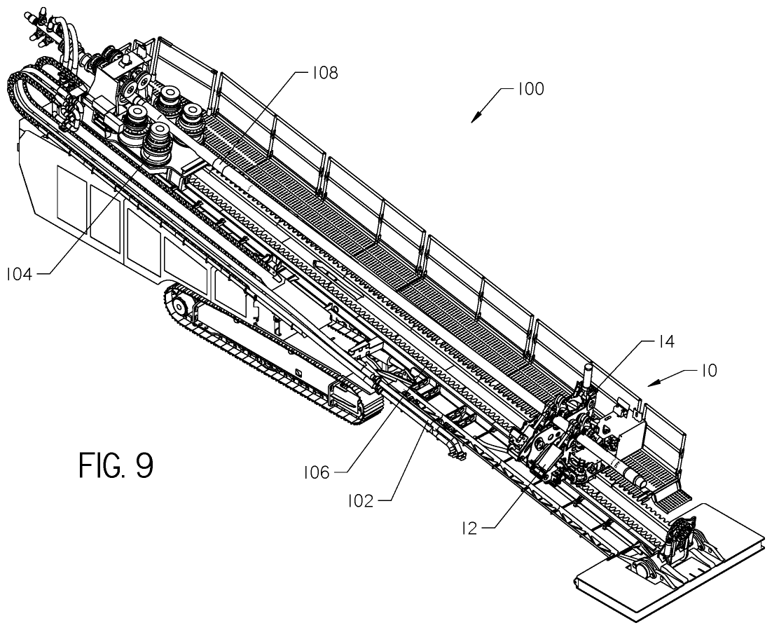

In FIG. 9, the horizontal directional drilling machine 100 is shown for reference. The machine 100 comprises a frame 102 and a carriage 104 which is movable over the frame 102. The carriage 104 may move on a rack 106. The carriage 104 supports a spindle 108. The carriage provides thrust and retraction to pipe segments which are carried on the spindle 108, while the spindle provides rotational force, such as that associated with drilling.

The wrench assembly 10 is supported on the frame 102. Such wrenches 10 are used to provide high-torque to a drill string joint, such as when adjacent segments of a pipe string are being joined or separated. Joining of pipe segments takes place when the pipe string is being advanced away from the drilling machine 100 to add length to the drill string. Separation takes place when the pipe string is being retracted in a direction toward the drilling machine 100. Some applications make use of a drilling machine on each side of a borehole to provide additional power to the drilling (or backreaming) operation, but the general procedure of making or breaking a pipe joint remains the same. One such wrench assembly for a drilling machine is shown in U.S. Pat. Pub. No. 2017/0130540, Metcalf, et al., the contents of which are incorporated herein by reference.

Conventional wrenches for drilling machines often utilize two points of contact per wrench in an opposed orientation. For many applications, this arrangement is acceptable. However, as pipe size increases and more force is needed to overcome frictional forces, the force placed upon pipe joints by wrench assemblies may cause the warping or bowing of the pipe at the joint.

To overcome this, some have created wrench assemblies with three points of contact, each powered by an individual cylinder or ram. However, as these rams and points of contact are only offset by 120 degrees, the wrenches do not have openings, requiring pipe segments to be threaded through an aperture rather than set in a “cradle”, increasing the time associated with each operation.

The wrench assembly 10 of the present invention combines the positive features of both of the above described designs while dispensing of the drawbacks. Each jaw is approximately 120 degrees from each other jaw, and yet the wrench assembly has an “open top”, which allows better visibility and simpler addition/removal of pipe segments from the drilling machine 100.

The wrench assembly 10 comprises a stationary wrench 12 and a rotating wrench 14. Each of the wrenches 12, 14 has an aligned cradle 13. The cradles 13 are generally aligned with the longitudinal axis of a pipe string (not shown). In addition, the wrench assembly 10 does not require a “dog bone” or other structural element to be placed across the assembly to keep the gripping forces from pushing the wrench apart.

Typically, the rotating wrench 14 is referred to as a “rear wrench” and the stationary wrench 12 as a “front wrench”. This is because at the front of a drilling machine, the pipe string is disposed through an underground environment, making rotation of a pipe segment impractical. The “rear” wrench only rotates a single pipe segment, making rotation of this wrench optimal.

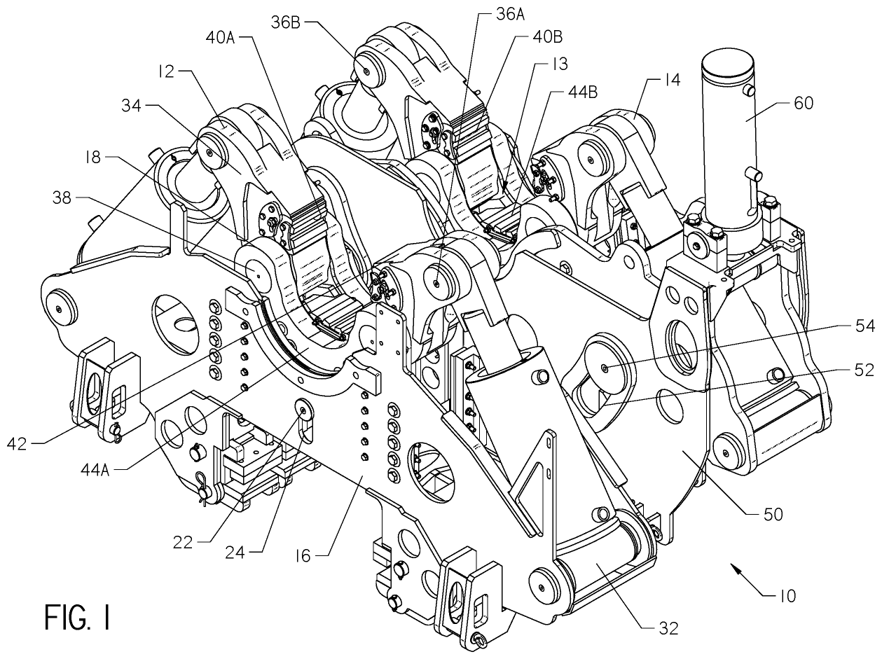

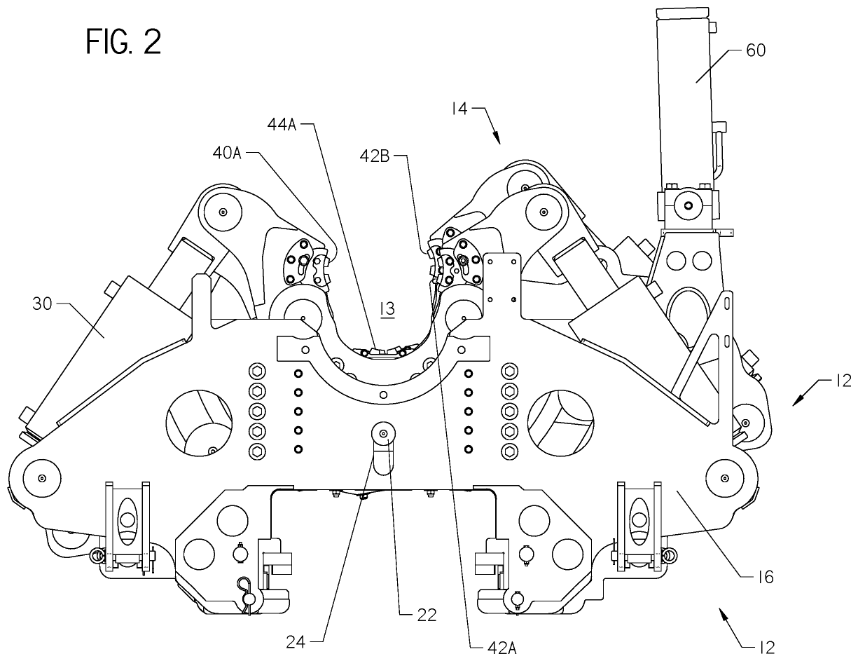

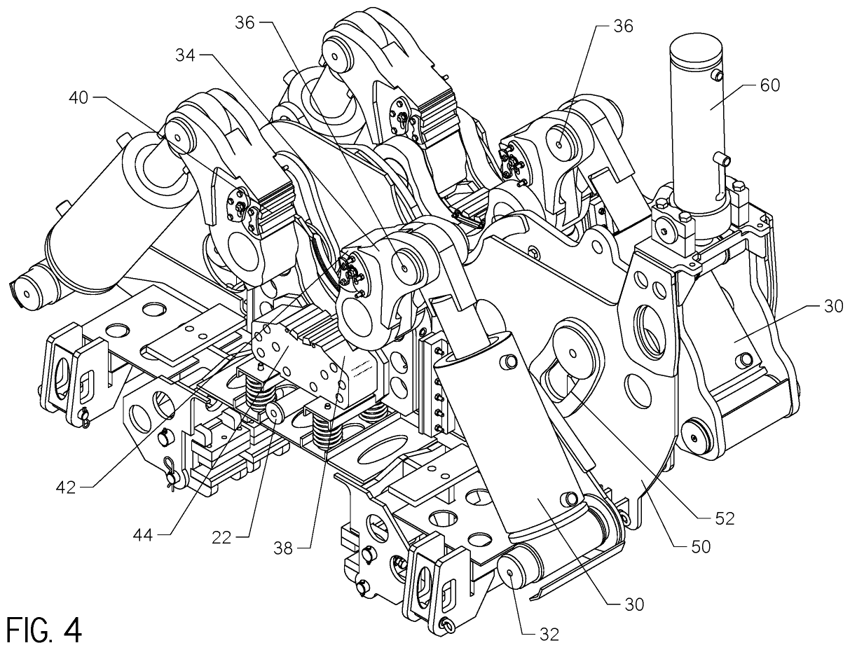

With reference to FIGS. 1-5B, the stationary wrench 12 comprises a stationary wrench frame 16 and a stationary wrench jaw assembly 18. The stationary wrench jaw assembly 18 is supported on one or more springs 20. The springs 20 bias the stationary wrench jaw assembly 18 away from the stationary wrench frame 16. The travel of the stationary wrench jaw assembly 18 is limited by a pin 22 attached to the assembly 18 and disposed through a slot 24 on the frame 16. The stationary wrench jaw assembly 18 further includes an inner frame 26 which rides within an associated limiter 28 attached to the frame 16. The limiter 28 may comprise one or more slots which allow the inner frame 26 to move in the direction of the spring 20 force, but not in any direction perpendicular to the spring 20 force.

The stationary wrench 12 further comprises a pair of cylinders 30 attached to the frame 16 at a pair of first pivot points 32 and attached to a pair of clamping arms 34 at a pair of second pivot points 36. The pair of clamping arms 34 are pivotally attached to the inner frame 26 at a pair of third pivot points 38. A first jaw 40 is supported on one of two clamping arms 34, a second jaw 42 is supported on another of the two clamping arms 34, and a third jaw 44 is supported on the inner frame 26.

Thus, as the cylinders 30 extend, the inner frame 26 and clamping arms 34 move up (in FIG. 1) until the third jaw 44 abuts the pipe joint (usually at a point at the bottom of the pipe joint). Further extension causes the clamping arms 34 to pivot about the third pivot points 38, closing over the pipe joint until the first jaw 40 and second jaw 42 also abut the pipe joint. In this way, two cylinders actuate three separate jaws 40, 42, 44 to provide clamping force.

The cylinders 30 may likewise retract, pulling the first jaw 40 and second jaw 42 away from the pipe joint, allowing the pipe string to be advanced without interference from the wrench 12. Once the pair of clamping arms 34 are sufficiently pulled away from the pipe joint, the third jaw 44 will pull away from the pipe joint as the inner frame 26 travels in a downward direction (along slot 24).

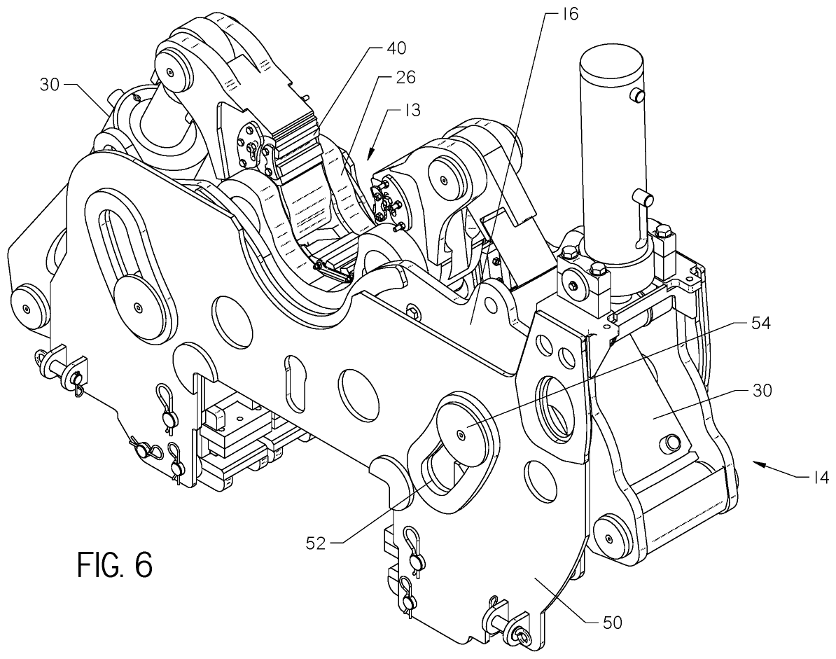

As best shown in FIGS. 6-7 and 10, the rotating wrench 14 is substantially similar to the stationary wrench 12. Therefore, components of the rotating wrench 14 are given the same reference numbers as like components of the stationary wrench, except when particularly noted herein. When a distinction is required, the like elements of the stationary wrench are given the modifier “A”, and the elements of the rotating wrench the modifier “B”. Therefore, the third jaw 44A denotes this element on the stationary wrench 12, the second pivot point 36B denotes this element on the rotating wrench 14, and so on. Because these elements are repeated and often functionally equivalent, the modifiers are used sparingly for simplicity.

The primary difference between the rotating 14 and stationary 12 wrench is that the rotating wrench 14 is disposed such that it is supported by a rotation plate 50. The rotation plate 50 is attached to, and not rotatable relative to, the stationary wrench 12 and includes one or more slots 52. A pin 54 extends from the rotating wrench 14 and, together with the slot 52, provides a limitation of the range of motion of the rotating wrench 14. Rotation cylinders 60, 61 extend from a stationary frame element to rotate the frame 16 of the rotating wrench 14.

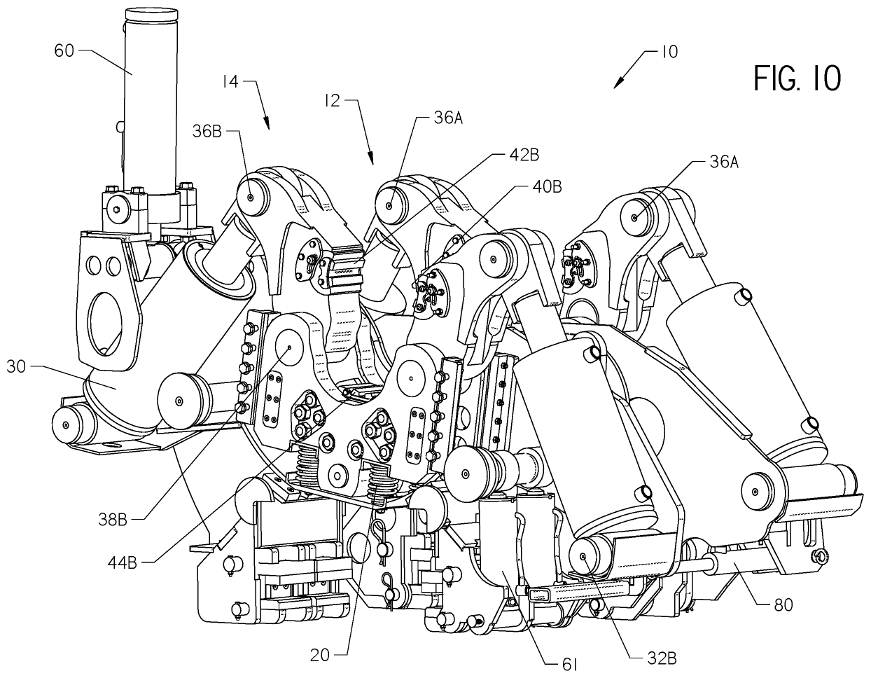

One or more rotation cylinders 60 may extend to rotate the inner frame 26 relative to the rotation plate 50 and the stationary wrench 12, allowing torque to be provided to a pipe joint when the jaws 40, 42, 44 are engaged. The cylinders 60 are force-coupled with a set of cylinders 61 on the bottom of the rotating wrench 14. As shown in FIG. 10, cylinder 60 is sized differently and at a different location relative to the center of rotation of the rotating wrench 14 than the set of cylinders 61. As shown, the set of cylinders 61 are closer to a center of rotation and smaller. However, because the cylinder 60 and set of cylinders 61 are force-coupled, the torque applied to the pipe within the cradle 13 does not place undue forces on the wrench 14 frame itself.

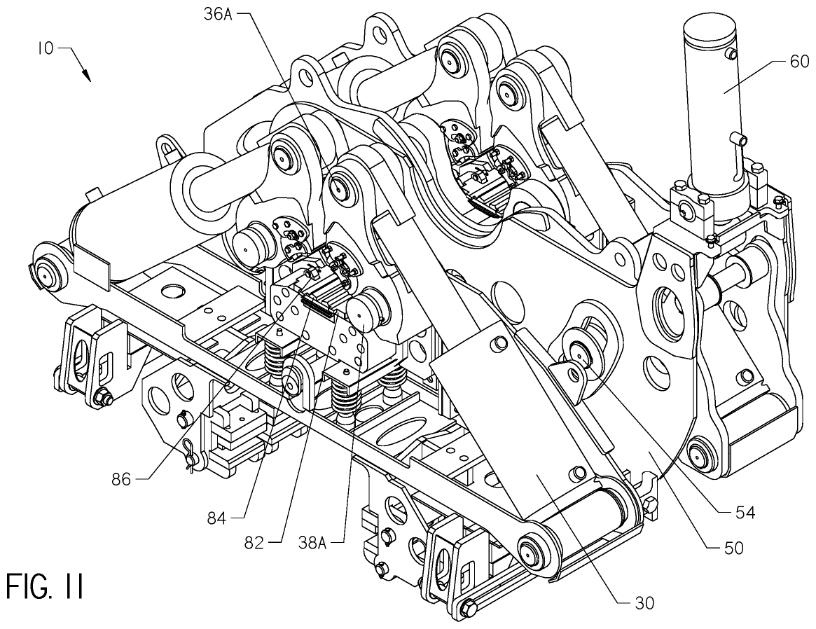

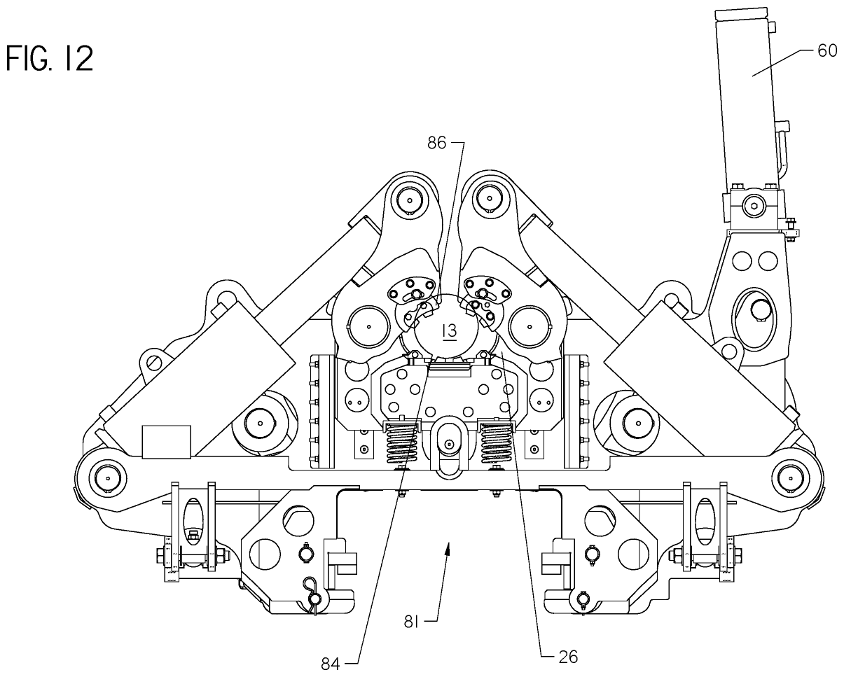

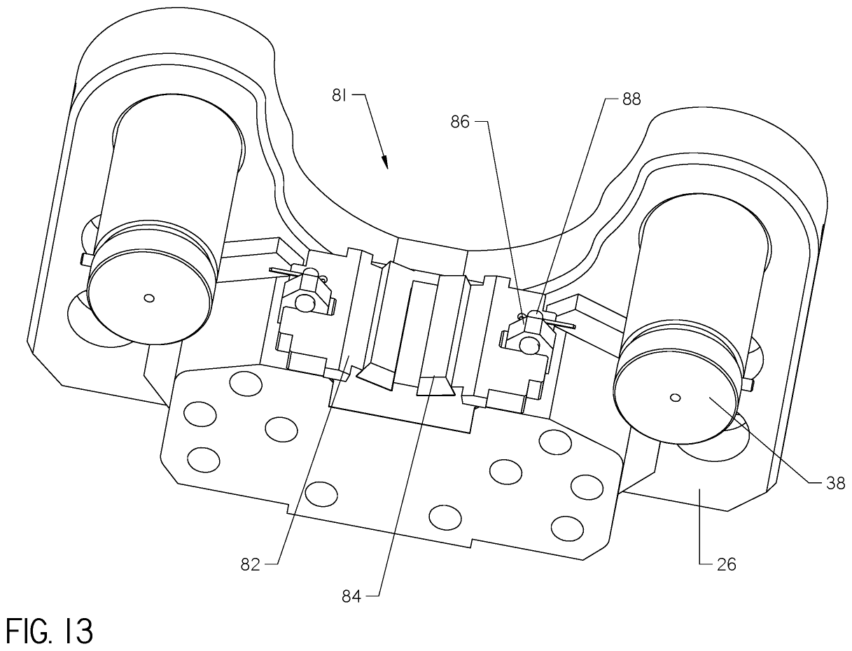

As shown in FIG. 11, the third jaw 44 (whether jaw 44A or 44B) is shown in an alternative embodiment. The third jaw 44 differs from the first 40 and second 42 jaws in that it never overhangs the pipe segment. In the case of the first 40 and second 42 jaws, their location at a periphery of the wrench assembly 10 allows access for replacement of elements, such as dies, which may wear. However, the third jaw 44 is in a difficult to access position, disposed on the inner frame 26 and surrounded by fixed elements, such as the third pivot points 38, of the wrench assembly 10. Accordingly, a removable die assembly 81 is provided. As best shown in Figure X, the die assembly comprises an insert 82, a hardened die 84, two tabs 86 and two pins 88.

The removable die assembly 81 is situated within the frame of the movable 14 or stationary 12 wrench. As shown, two dies 84 are situated within the assembly 81, and adapted to contact the pipe segment or pipe joint disposed within the cradle 13. While two dies 84 are shown, other numbers may be shown. The dies 84 are sacrificial, wearing as the wrench assembly 10 is used. The insert 82 is configured to be placed about the dies 84, holding them into position. The tabs 86 extend through slots 85 disposed in the insert 82, locating the insert 82 within the wrench assembly 10.

Because the third jaw 44 faces in a generally upward direction (with some variation in the rotating wrench 14), the insert 82 and dies 84 may rest within the cradle 13 and fit within the inner frame 26. The tabs 86 define an aperture disposed above the level of the insert 82. Pins 88 may be located within the apertures to prevent accidental removal of the insert 82, but need not bear against the insert 82 itself.

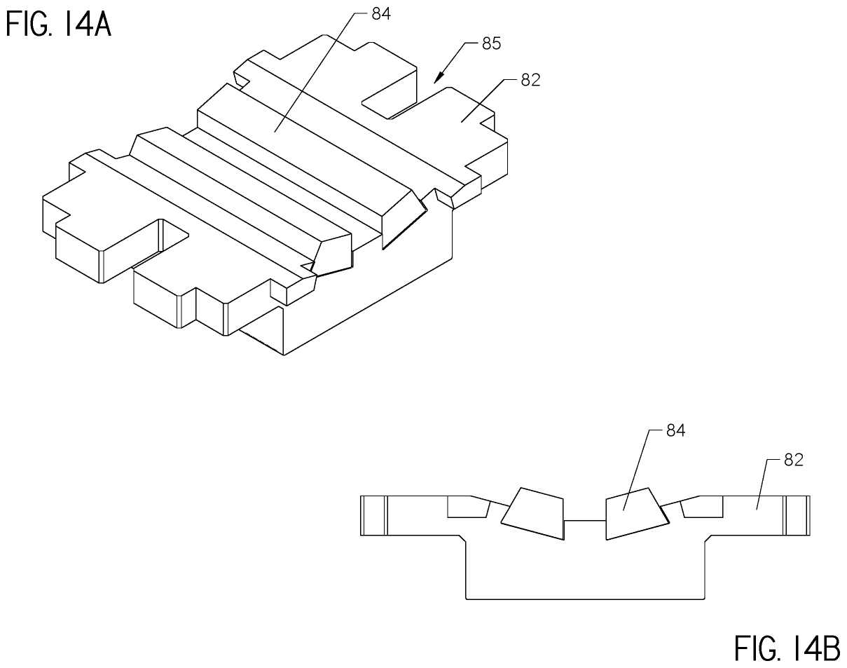

Thus, to replace worn out dies 84, an operator need only remove pins 88 from the tabs 86, then remove the insert 82 from the wrench assembly 10. The dies 84 then become removable, and may be replaced. The same insert 82 may be placed about replacement dies, and the pins 88 reinserted. The insert is shown in detail in FIGS. 14A and 14B.

In operation, a pipe joint is placed such that the rotating wrench 14 is on three sides of a first pipe segment and the stationary wrench 12 is on three sides of a second pipe segment. The cylinders 30B are actuated, and the inner frame 26B moves upwards until the third jaw 44B abuts a pipe segment (not shown). The first 40 and second 42 jaws then pivot, allowing three points of contact.

When the cylinders 30A, 30B of each of the stationary 12 and rotating wrench 14 are extended and a pipe segment is in the cradle 13, it should be appreciated that the second pivot points 36A, 36B are “over center” relative to the third pivot points 38A, 38B. Such over-center structures provide a mechanical advantage for maintenance of the jaws 40, 42, 44 on the pipe segment.

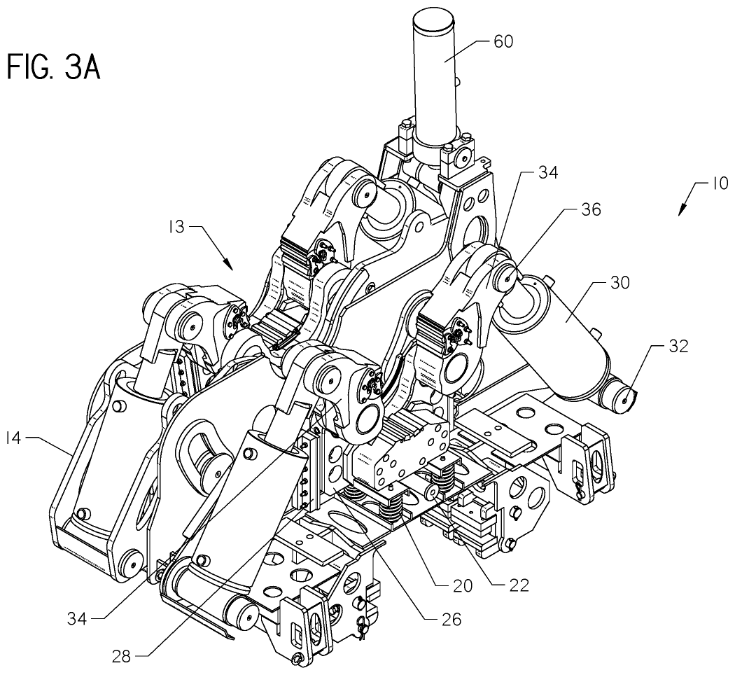

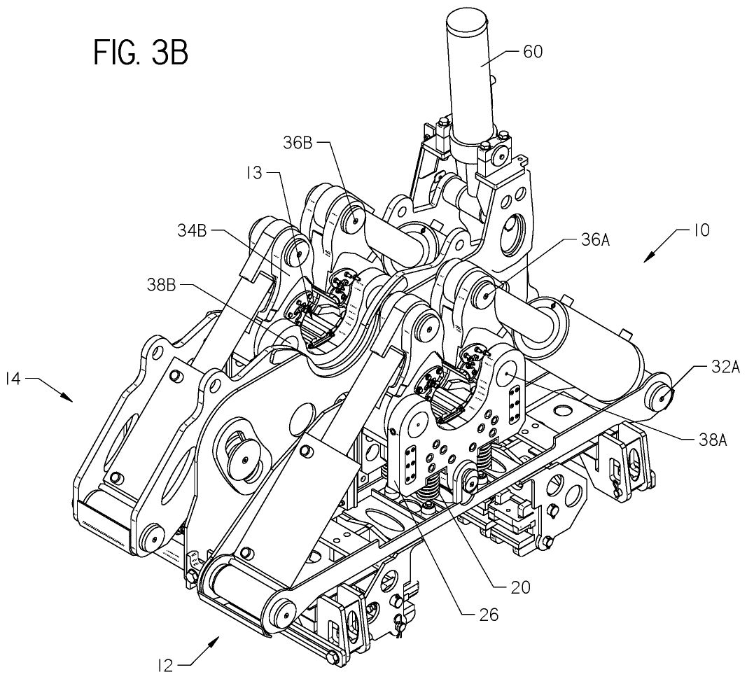

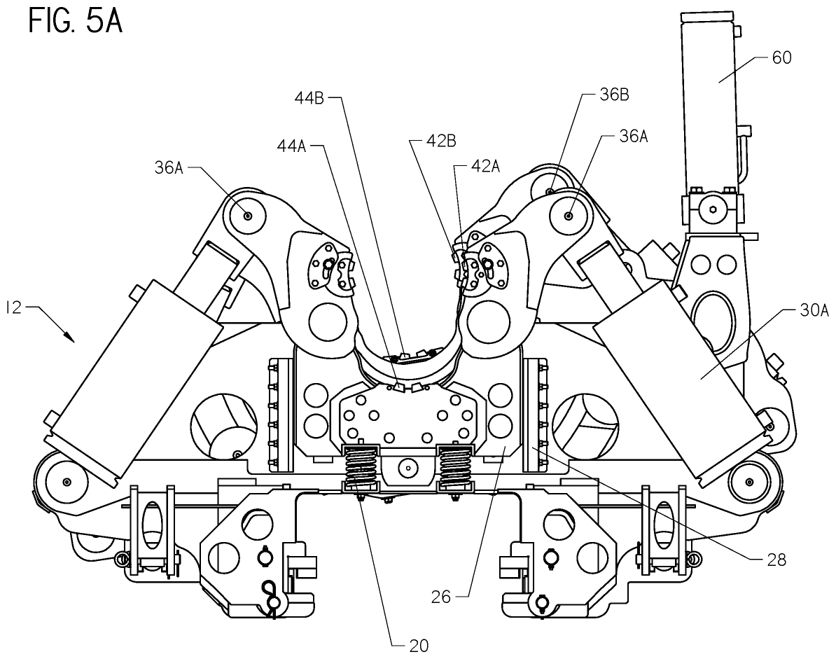

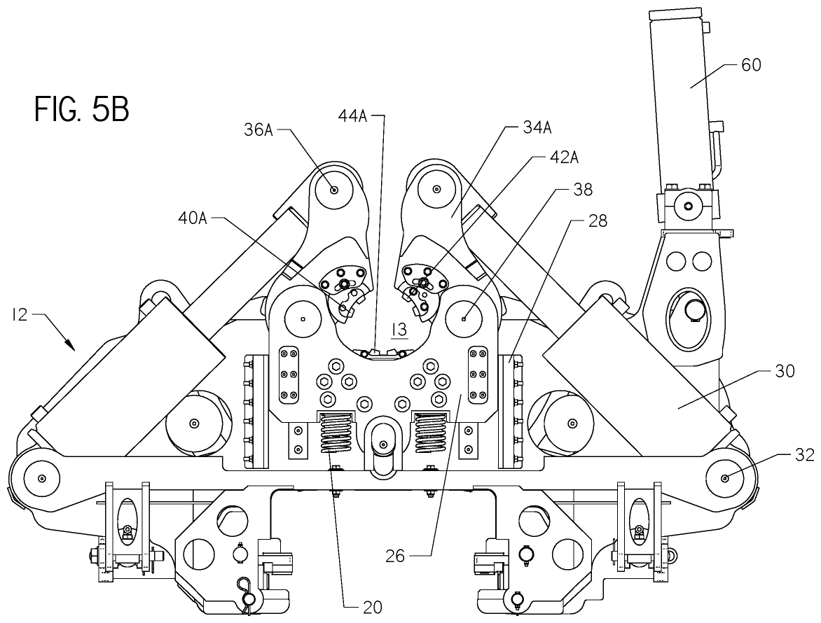

This distinction can be shown by FIGS. 3A-3B and 5A-5B. When in an “open” position, in FIGS. 3A and 5A, the cradle 13 is available from its top side for placement of a pipe segment. The inner frame 26 is lowered and the second pivot points 36 are further apart than the third pivot points 38, with the clamping arms 34 angled outwardly.

When in a “closed” position in FIGS. 3B and 5B, the cylinders 30 are extended, the springs 20 extend as the inner frame 26 moves upwards in the slot 28. Clamping arms 34A, 34B pivot about the third pivot points 38A, 38B until the second pivot points 36A, 36B are closer to one another than the third pivot points. This results in the clamping arms substantially surrounding the cradle 13 and any pipe segment or pipe joint located therein. In the “closed” position, each of the jaws 40, 42, 44 is on a separate one of three sides of the cradle 13.

It should be appreciated that pipe segments and pipe joints may come in various sizes. The present set of wrenches 12, 14 are capable of providing torque to multiple sizes, as the cradle 13 is not constrained by an aperture or other structure sized to a particular pipe. Larger pipe joints may cause the angle between the first 40 and second 42 jaw to be greater than 120 degrees. Smaller pipe joints may cause the angle between these jaws to be less than 120 degrees. However, within a certain range, three points of contact will be preferable to two, even if the jaws 40, 42, 44 are not distributed evenly.

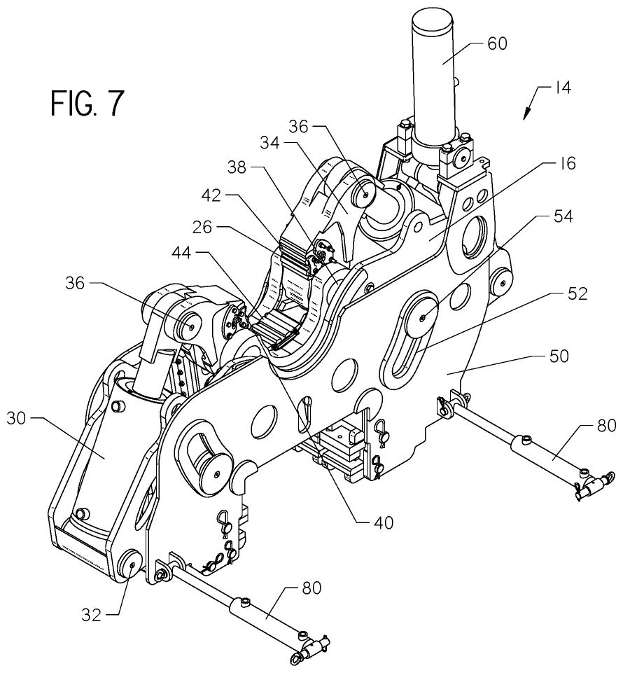

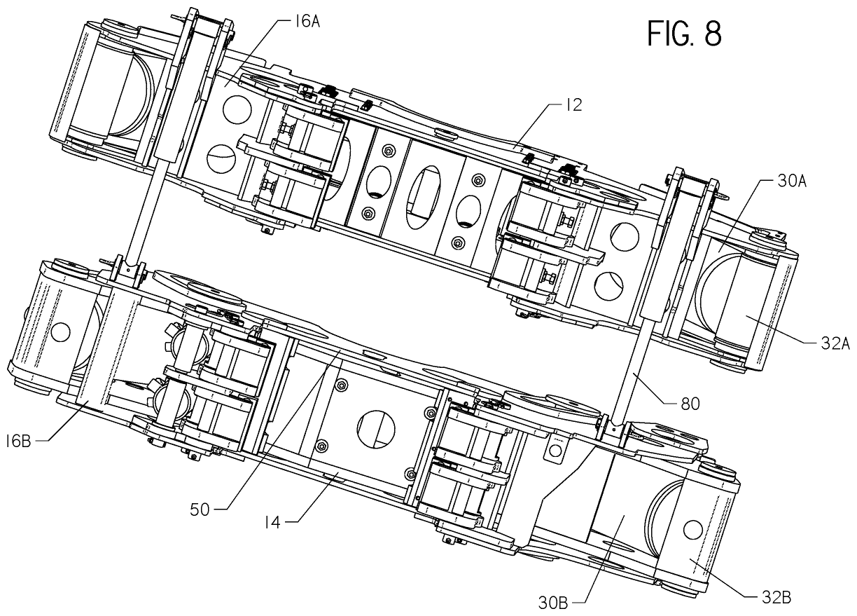

Further, as shown in FIGS. 7 and 8, one or more position cylinders 80 may extend or retract to change a distance between the stationary wrench 12 and rotating wrench 14. The wrenches 12, 14 may thus be fine-tuned for placement at the optimum position on a pipe joint. As shown, the barrel end of cylinders 80 is attached to the stationary wrench 12 and the rotating wrench 14 is adjusted, though this arrangement may be reversed.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A pipe wrench comprising:
a first frame;
a second frame slidingly supported by the first frame;
a first arm, pivotally attached to the second frame at a first pivot point;
a second arm, pivotally attached to the second frame at a second pivot point;
a first cylinder, attached at a first end to the first frame and a second end to the first arm at a third pivot point; and
a second cylinder, attached at a first end to the first frame and a second end to the second arm at a fourth pivot point;
wherein the first pivot point and second pivot point are separated by a first distance; and
wherein the first and second cylinder are configured to move the first and second arm from a first condition to a second condition;
wherein the first condition is defined by the third and fourth pivot points being separated by a distance greater than the first distance; and
the second condition is defined by the third and fourth pivot points being separated by a distance less than the first distance.

2. The pipe wrench of claim 1 in which each of the first arm, second arm, and second frame each support a jaw.

3. A system comprising:
the pipe wrench of claim 1, characterized as a first pipe wrench; and
a second pipe wrench comprising the components of the first pipe wrench;
wherein the second pipe wrench is rotatable relative to the first pipe wrench.

4. The system of claim 3 in which the first pipe wrench and second pipe wrench are separated by an adjustable distance.

5. The pipe wrench of claim 1 further comprising a removable jaw assembly, wherein the removable jaw assembly is supported on the second frame and comprises:
at least one hardened die;
a removable insert disposed about the hardened die; and
a retainer configured to retain the removable insert on the second frame.

6. The pipe wrench of claim 1, further comprising:
a third frame comprising at least one arcuate slot;
wherein the first frame comprises at least one pin disposed through the arcuate slot and the first frame is movable relative to the third frame along a path defined by the at least one arcuate slot.

7. The pipe wrench of claim 6 further comprising:
a first rotation cylinder configured to move the first frame relative to the third frame; and
at least one second rotation cylinder configured to move the first frame relative to the third frame.

8. The pipe wrench of claim 7 in which the first rotation cylinder and the at least one second rotation cylinder are of different sizes.

9. A pipe wrench assembly comprising:
a stationary wrench comprising:
a first jaw, second jaw, and third jaw;
wherein the second jaw and third jaw are each pivotal relative to the first jaw; and
a rotating wrench comprising:
a fourth jaw, fifth jaw, and sixth jaw;
wherein the fifth jaw and sixth jaw are each pivotal relative to the fourth jaw; wherein the rotating wrench is rotatable relative to the stationary wrench.

10. The pipe wrench assembly of claim 9 in which the second jaw and third jaw of the stationary wrench are each configured to pivot over center relative to the first jaw of the stationary wrench.

11. The pipe wrench assembly of claim 9 in which the stationary wrench comprises:
a first frame;
a second frame, slidingly attached to the first frame, wherein the first jaw is supported on the first frame;
a first arm, pivotally attached to the second frame, wherein the second jaw is supported on the first arm; and
a second arm, pivotally attached to the second frame, wherein the third jaw is supported on the second arm.

12. The pipe wrench assembly of claim 11, further comprising:
a first cylinder, disposed between the first frame and the first arm; and
a second cylinder, disposed between the first frame and the second arm.

13. The pipe wrench assembly of claim 11, further comprising:
a spring assembly disposed between the first frame and the second frame, configured to bias the second frame away from the first frame.

14. The pipe wrench assembly of claim 9 wherein the first jaw and fourth jaw each comprise a removable die assembly, wherein the removable die assembly comprises:
a tab disposed on the second frame;
an insert defining a slot, wherein the slot is configured to cooperate with the tab to locate the insert on the second frame;
at least one die, positioned on the second frame by the insert; and
a pin disposed through the tab, the pin having a length longer than a width of the slot.

15. A method of replacing a worn die using the pipe wrench assembly of claim 14, comprising:
removing the pin from the tab;
separating the insert from the second frame;
separating the worn die from the insert;
placing a replacement die into the insert;
locating the insert on the second frame, wherein the tab is disposed through the slot of the insert; and
placing the pin through the tab.

16. The pipe wrench assembly of claim 9 further comprising at least one position actuator disposed between the stationary wrench and the rotating wrench, wherein a distance between the stationary wrench and the rotating wrench is configured to be adjusted by the position actuator.

17. A drilling machine comprising:
a spindle for rotating a drill string;
a carriage for providing thrust to the drill string; and
the pipe wrench assembly of claim 9, configured to provide high torque joining or separating of segments in the drill string.

18. The wrench assembly of claim 9 wherein the rotating wrench comprises:
a first cylinder configured to pivot the second jaw relative to the first jaw;
a second cylinder configured to pivot the third jaw relative to the first jaw
a third cylinder configured to pivot the fifth jaw relative to the fourth jaw;
a fourth cylinder configured to pivot the sixth jaw relative to the fourth jaw; and
at least one rotation cylinder configured to rotate the rotating wrench relative to the stationary wrench.

19. A method of using the wrench assembly of claim 18 comprising:
placing a pipe joint within the wrench assembly, the pipe joint comprising a first pipe threaded to a second pipe, wherein the first pipe is above the first jaw and the second pipe is above the fourth jaw;
activating the first cylinder and the second cylinder such that the first jaw, second jaw, and third jaw grip the first pipe;
activating the third cylinder and the fourth cylinder such that the fourth jaw, fifth jaw, and sixth jaw grip the second pipe; and
while the first pipe and the second pipe are gripped, rotating the rotating wrench with the at least one rotation cylinder, thereby rotating the second pipe relative to the first pipe.

20. The method of claim 19 wherein the first pipe is at least partially underground.
